(19) United States
(12) Patent Application Publication
(10) Pub. No.: US 2007/0143347 A1
(43) Pub. Date: Jun. 21, 2007

(54) Method and system for a buyer real estate information service

(75) Inventor: Marc J. McGee, Potomac, MD (US)

Correspondence Address: ARENT FOX PLLC, 1050 CONNECTICUT AVENUE, N.W., SUITE 400, WASHINGTON, DC, 20036, US

(73) Assignee: FAIRSALE, LLC.

(21) Appl. No.: 11/607,092

(22) Filed: Dec. 1, 2006

Related U.S. Application Data
(60) Provisional application No. 60/741,078, filed on Dec. 1, 2005.
(60) Provisional application No. 60/831,456, filed on Jul. 18, 2006.

(51) Int. Cl. G06F 17/00

(52) U.S. Cl. 707/104.1

(57) ABSTRACT

A method for providing buyer real estate information. The method includes receiving at least one buyer related search criterion; performing a search of a data repository containing buyer real estate information using the at least one selected buyer related search criterion; and identifying any buyer in the data repository matching the at least one selected buyer related search criterion.

This application claims priority to Applicant's co-pending U.S. Provisional Application Ser. No. 60/741,078 entitled “METHOD AND SYSTEM FOR A BUYER REAL ESTATE INFORMATION SERVICE” filed Dec. 1, 2005, and co-pending U.S. Provisional Application Ser. No. 60/831,456 entitled “METHOD AND SYSTEM FOR A BUYER REAL ESTATE INFORMATION SERVICE” filed Jul. 18, 2006. The entirety of each of these patent applications is incorporated herein by reference.

### BACKGROUND OF THE INVENTION

1. Field of the Invention

The present invention relates generally to a method and system for providing buyer information in a real estate market, and in particular to a method and system that provides buyer information and allows input for users based on predetermined criteria, such as a buyer's price range, geographic interest, and other information relevant to the buyer.

2. Background of the Technology

Success in the residential brokerage industry is in large part reliant upon the use of the Multiple Listing Service (“MLS system”). In the residential brokerage industry, real estate buyers are able to search for available real estate through a database containing information on properties for sale. The MLS system, for example, provides agents selling real estate with the ability to describe a subject property in detail. A description of the property is typically received by a real estate listing agent, input into the MLS system and disseminated through the MLS system, so that other real estate agents and prospective buyers can view the details of the property. When a real estate agent lists a property for sale, property information, such as price, address, picture, conditions for purchase, real estate commissions and contact information, is entered into the system and becomes immediately available to other subscribers to the MLS system. The MLS system is an especially effective marketing tool in the sale of residential properties in a seller's market. Sellers looking to sell real estate have a system by which selling information can be accessed by buyers easily.

The MLS system delivers information related to residential property being offered for sale. In a “sellers' market”, where buyers' agents search in a competitive and often limited market for suitable homes for their buyers, the MLS system provides preliminary information necessary to begin a transaction. In a “buyer's market”, there are generally a greater number of properties for sale, but fewer buyers available to purchase the properties. In a buyer's market, prices may increase slowly, then stabilize, and finally drop, as numerous sellers compete to attract the limited pool of buyers. The number of listings entered into and remaining on the MLS system grows rapidly as properties remain unsold for longer periods of time, or do not sell. The attention any one property receives through the MLS system decreases correspondingly as the number of property entries grows.

There remains a need for a system that delivers information particularly relating to the buyer seeking to purchase residential property. Such a system would be particularly valuable in a buyer's market because in this situation there are typically few buyers and many sellers who are seeking to identify the few buyers.

### SUMMARY OF THE INVENTION

The present invention includes a method and system for providing buyer real estate information to users that is tailored to the requirements of the buyer. In the present application, the term “users” indicates buyers, sellers and/or real estate agents, as well as others seeking buyer information. In an embodiment of the present invention, a single repository, such as a database or database farm, is used with middle tier software on servers in a network, such as the Internet, the World Wide Web, a local area network (LAN), a wide area network (WAN) and a wireless communication network. Such information is provided through and accessed via user terminals coupled to the network. For example, information and fields directed to the requirements that a buyer may have for any property are input to the system by a system operator, who for example, may make such input so as to control quality.

The present invention is not limited to application in a buyer's market, but can also be applied in a seller's market.

Example embodiments of the present invention have now been described in accordance with the above advantages. It will be appreciated that these examples are merely illustrative of the invention. Many variations and modifications will be apparent to those skilled in the art.

### BRIEF DESCRIPTION OF THE DRAWINGS

FIG. 1 is an example components diagram for a system in accordance with one embodiment of the present invention;

FIGS. 2A and 2B are example user input screens in accordance with one embodiment of the present invention;

FIG. 3 is an example user input screen in accordance with one embodiment of the present invention;

FIG. 4 is an example flowchart for creating a buyer profile;

FIG. 5 is an example buyer requirement information screen in accordance with one embodiment of the present invention;

FIG. 6A is an example user search screen in accordance with one embodiment of the present invention;

FIG. 6B is an example user search screen in accordance with one embodiment of the present invention;

FIG. 7 is an example flowchart for searching for a buyer profile and

FIG. 8 illustrates a block diagram of various system components, in accordance with an embodiment of the present invention.

### DETAILED DESCRIPTION OF THE INVENTION

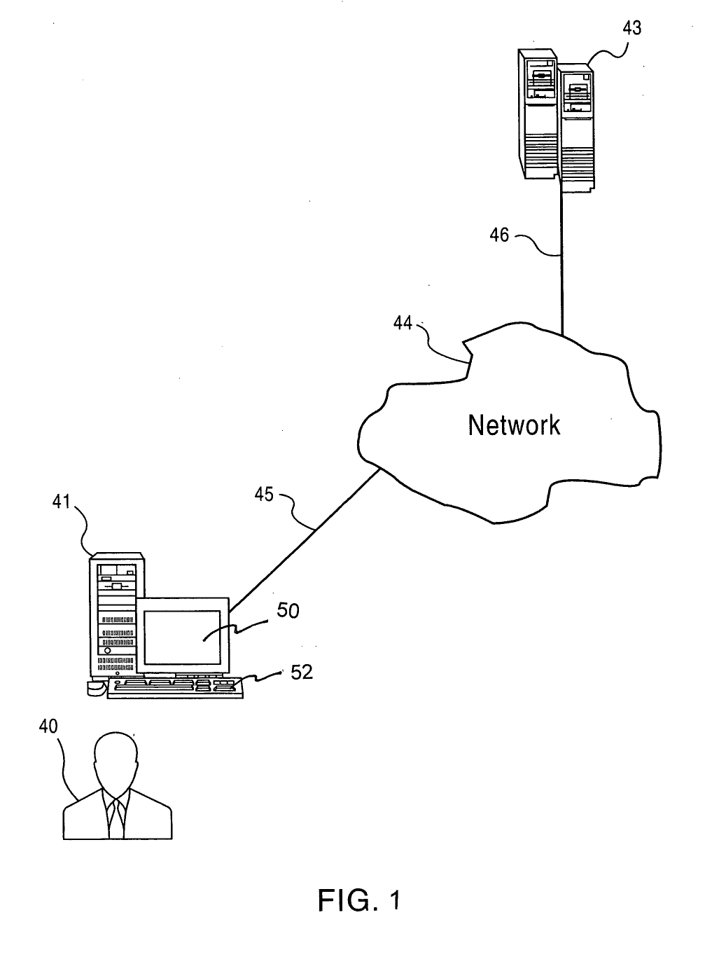

Access to the database and capabilities of the system of an embodiment of the present invention occur via hardware and access selections. As shown in FIG. 1, in an embodiment of the present invention, with one option, a user 40, for example, a buyer or a seller, can use locally loaded software at the user's terminal 41, such as a personal computer (PC), minicomputer, microcomputer, mainframe computer, telephone device, hand-held device such as a personal digital assistant (PDA), or other wireless device with a processor, display. The terminal 41 may also have the capability of connecting to a network 44, such as the Internet, World Wide Web, LAN, WAN and a wireless communication network. As another option, the user 40 can use the terminal 41 to access information via a server 43 on a network 44 via couplings 45, 46. The server 43 includes, for example, a PC, minicomputer, microcomputer, mainframe computer, or other device having a processor and a repository for data or connection to a repository for data. The couplings 45, 46 include, for example, wired, wireless, or fiber optic connections. In another embodiment, the method and system of the present invention operate in a stand-alone environment, such as on a single terminal.

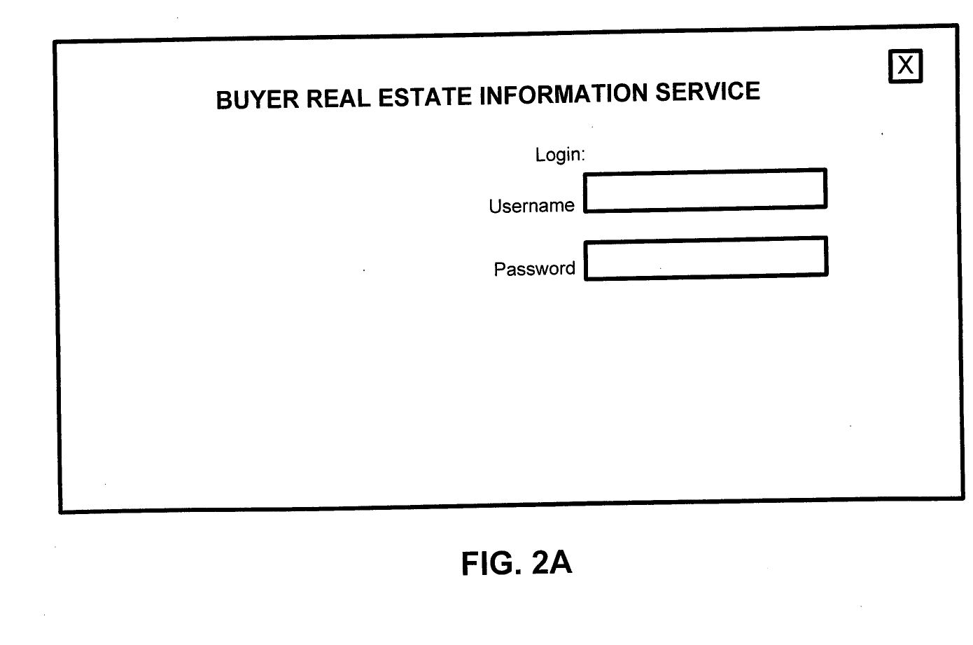

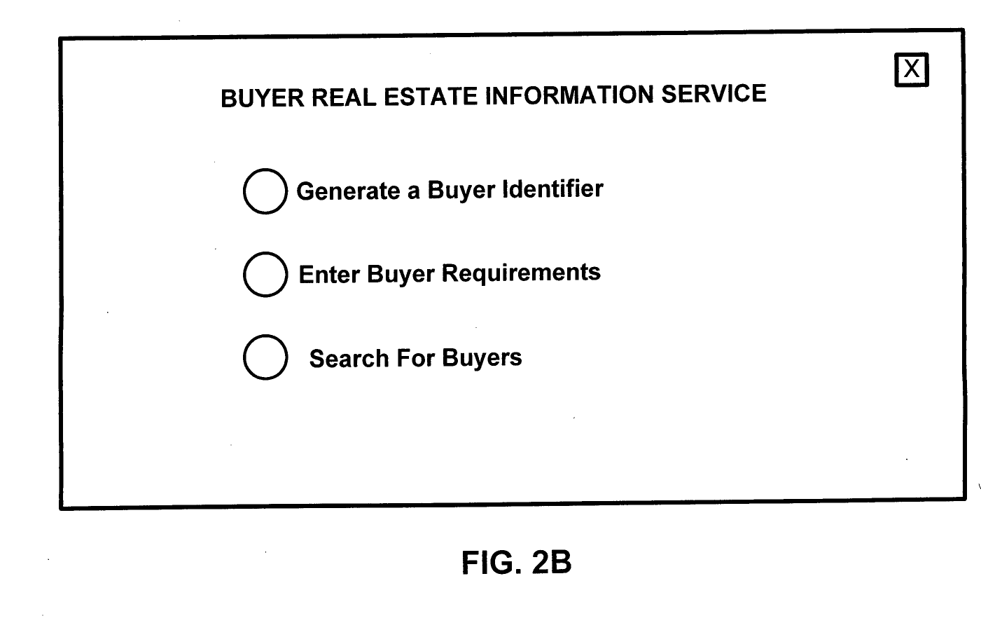

With either the locally loaded software option or the network option, the user is provided with selections for various options performable through the system. For example, upon entering a user name or user identifier and password, depending on the user authorization, the user 40 may input information or make modifications to data in the database. Such input and modifications are made, for example, through a graphical user interface (GUI). The GUI includes, for example, prompts for input regarding the buyer information to be input. Example GUI screens are presented in FIGS. 2A, 2B, 3, 5, and 6A.

One embodiment of the present invention includes features for populating information relating to the buyer for viewing or other access at the user terminal 41, such as the buyer's price range, financing status, and geographical requirements. Upon entry by the user of the buyer's requirements, the buyer's requirements are transmitted to the server 43 so that sellers can identify the buyer, such as for specific properties for sale that correspond to the buyer's requirements.

In one embodiment of the present invention, the user 40 is able to manually or otherwise selectively input buyer requirements, such as by typing into a keyboard or audibly providing voice input. Typical input includes a price range, age of house, number of bedrooms, number of bathrooms, and other buyer requirements.

A description of how a buyer is added to the database will now be described, in accordance with embodiments of the present invention. As with other aspects of data entry, addition of a new buyer is accomplished in some embodiments of the present invention via a network. The user of the system, which can be, for example, the buyer's real estate agent, may perform entry of a new buyer. The buyer provides the information regarding herself or himself to, for example, the real estate agent. The user uses a tool set allowing addition of the new buyer and prompting for selection and set up of the rules, fields, and other information specific to the buyer being added.

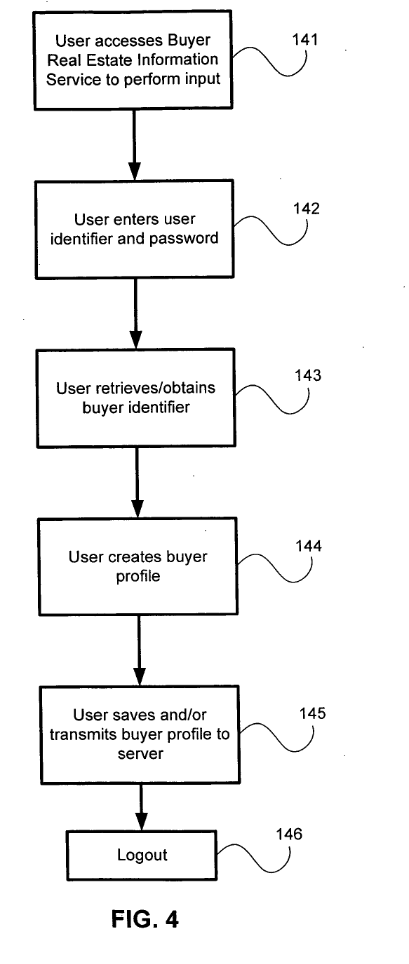

As shown in FIG. 1 and as further presented in the flowchart of FIG. 4, in one embodiment of the present invention, a host operator accomplishes database management. A set of specialized configuration and maintenance tools are used in order to maintain the actual database at the database level. For example, in one embodiment of the present invention, the system is based upon Oracle technology on the back-end. Java-based application servers are used in the middle (the “middle tier”), and programming languages and tools have been developed and are used to maintain the database and the infrastructure.

In the present invention, the user 40, via a computer terminal 41, accesses the Buyer Real Estate Information Service system and is able to post information anonymously. After the user enters a recognized user identifier and password as shown in FIG. 2A, for example and as shown in the steps 141-142 of FIG. 4, the computer terminal 41 will display on a screen 50 one or more GUI screens for the system, wherein the user can select the option of generating a buyer identifier, entering buyer requirements for real estate or searching for buyer profiles, as shown in FIG. 2B. (See also step 143 of FIG. 4).

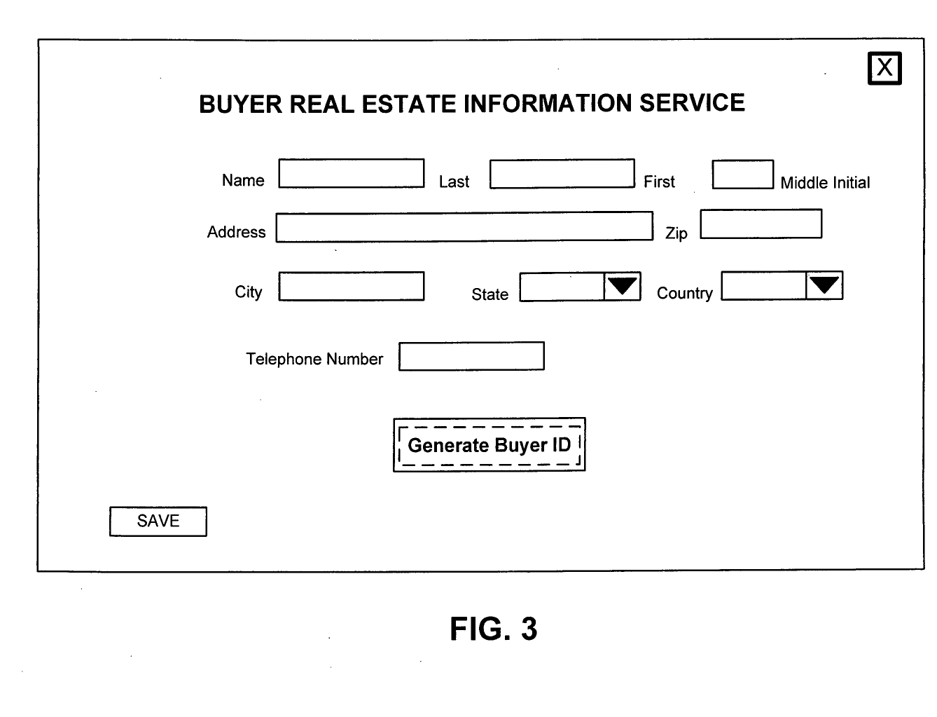

Generating a buyer identifier can be accomplished by entering the buyer's personal information displayed into the terminal as shown in FIG. 3 and transmitting the personal information of the buyer, such as their name, address and telephone number to the server. As further shown in the flowchart of FIG. 4, the server returns a new and unique identifier for the buyer at step 143. The buyer identifier replaces the buyer's real name in the database and can be assigned randomly or sequentially. When the real estate listing agent or seller performs a buyer search, the identifier is retrieved to identify the buyer, until such time that the buyer chooses to inform the selling parties of her or his name.

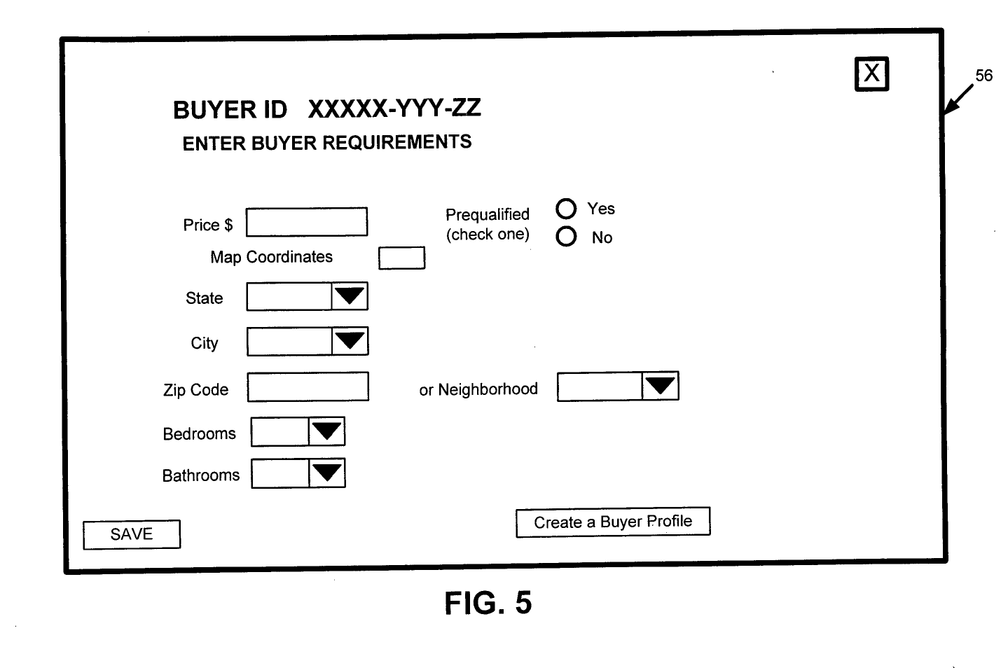

After the buyer identifier is generated, the user can create a buyer profile, as shown in FIG. 5. (See also step 144 of FIG. 4). The screen 50 (FIG. 1), for example, can display a form 56, such as a questionnaire, for the user to “enter” or “checkmark” the buyer's specific requirements for a property. The user can also rate the importance of each requirement to the buyer, such as, on a scale from one to ten.

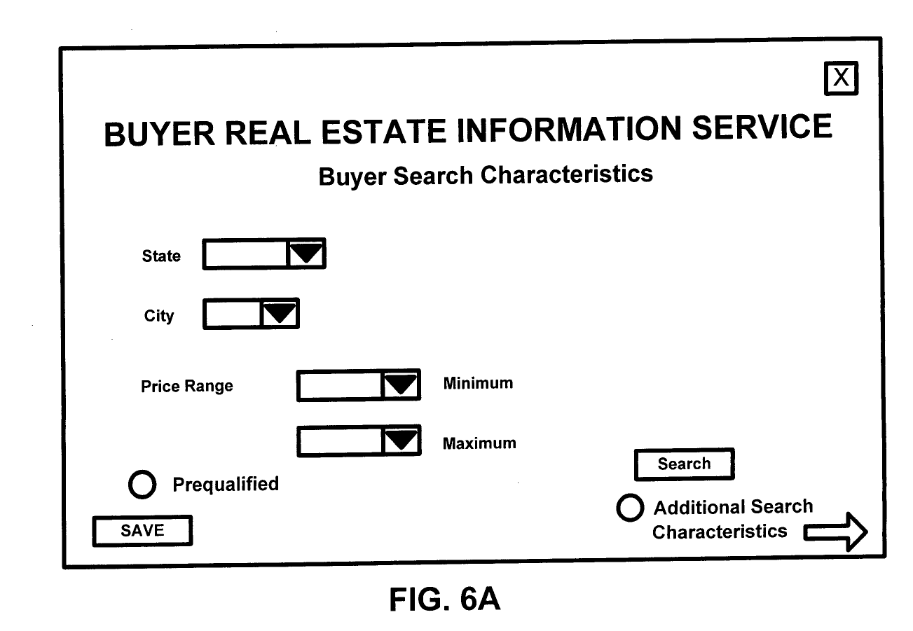

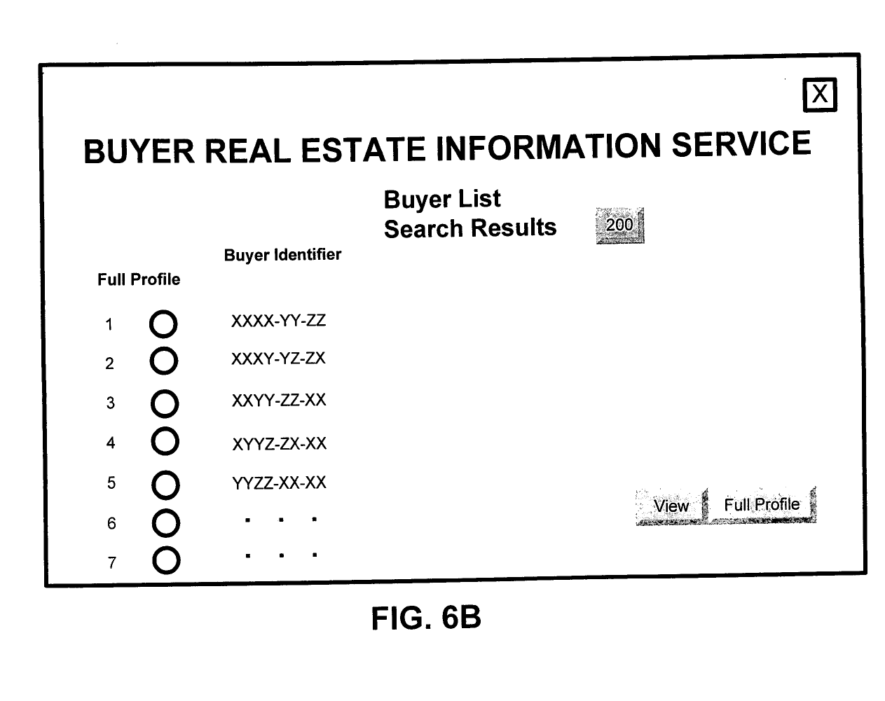

FIG. 6A illustrates an exemplary screen for entering the buyer requirements for real estate. The requirements can include the following selections: the name of the city/state/geographical area where the buyer wants to purchase a property; the buyer's price range; an option to select “yes” or “no” for whether the buyer is pre-qualified by a financial institution to purchase the home in the selected price range; the type of property that the buyer is looking for, such as single family, town home, semi-detached; zip code; number of bedrooms; number of bathrooms; number of levels; architectural style of property; age of home; square footage; exterior siding; parking availability; garage space; fireplace; basement; type of utilities; swimming pool; and deck.

After the user enters the buyer's required property criteria and characteristics into the Buyer Real Estate Information Service system, the user can choose to save the entries for later modification, or transmit the information to the server. (See also step 145 of FIG. 4). The user can exit the system at any time during the buyer profile entry. (See also step 146 of FIG. 4).

An example user interaction by a real estate listing agent for a seller to find potential buyers for a piece of property in the database, in accordance with an embodiment of the present invention, will now be described. For the browser-based interface, the user selects an option to perform a buyer search (e.g., selects a button on the GUI of FIG. 2B for buyer search). The user then inputs data as shown in FIG. 6A, designed to find buyers looking for particular characteristics of the property. The user can input preferred information, such as a buyer's geographical area and price range, and whether the buyer is pre-qualified for a mortgage loan. The search can also be conducted based on other criteria, such as the buyer's request for a specific number of bedrooms and bathrooms, a house of a certain age, or waterfront property. The user can then search for multiple buyers based upon these and/or any other selection criteria that are available in the system. The user then receives the search results from the database corresponding to the criteria input, in the form of a buyer list, as shown in FIG. 6b.

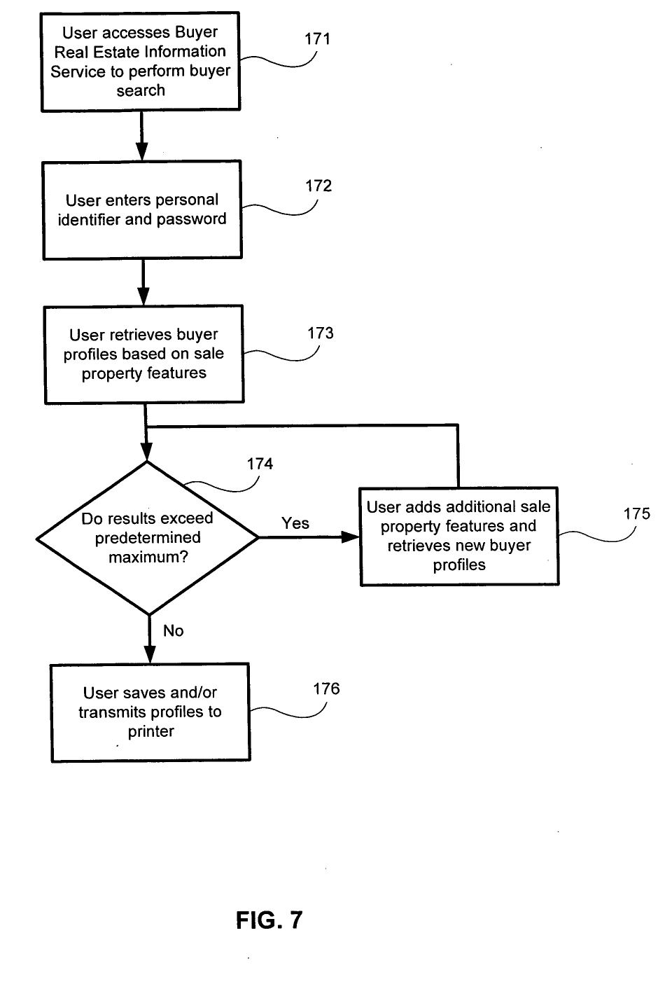

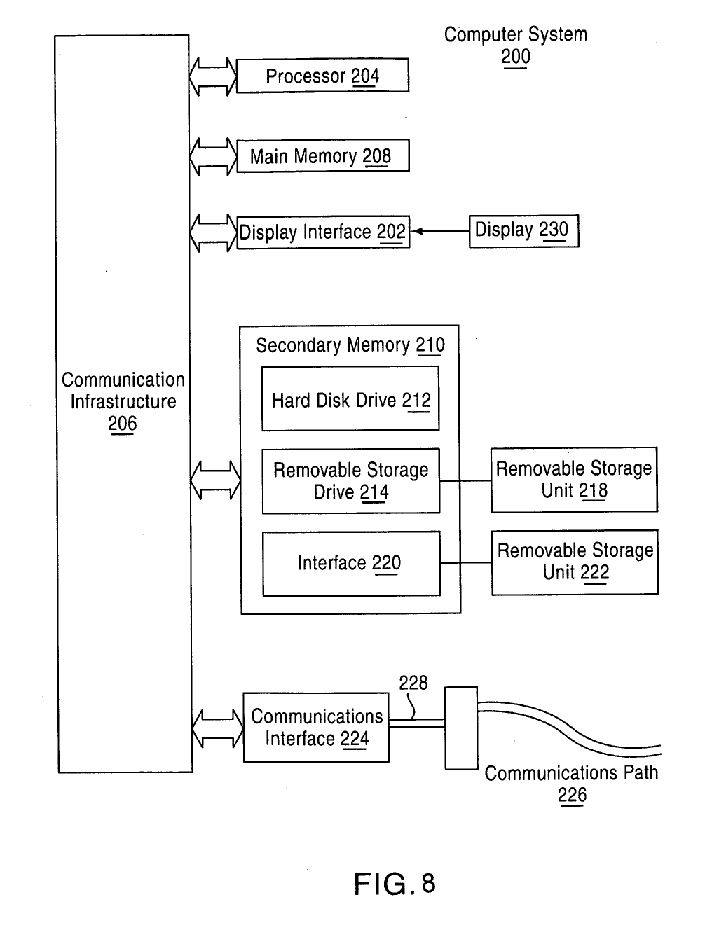

In the present invention, a real estate listing agent for a seller that is looking to sell a residential property to a prospective buyer can access available buyers that may be searching for the listed property, as described below. An exemplary flow chart for searching and refining searching in accordance with an embodiment of the present invention is shown in FIG. 7.

The user can access the system database, shown in FIGS. 2A and 2B, such as via a computer terminal. The user can enter any required identification in order to gain access to the database, such as a user identifier and password. (See also steps 171-172 of FIG. 7). The computer terminal can display the data retrieval prompt, such as “Search for Buyers” and, when data retrieval is selected, the terminal can display the data retrieval screen shown in FIG. 6B. The user can choose to retrieve a buyer profile (e.g., as shown in FIG. 5). The buyer profile can be retrieved based on the city, state, or geographical area where the seller's property is located. (See also step 173 of FIG. 7). The user can enter or select (e.g., from a pull down menu or other selection mechanism), for example, the city, state or geographical area. The user can then enter or select (e.g., from a pull down menu) a minimum price, a maximum price, or a price in between. The user can select “yes” or “no” as to whether the buyer is pre-qualified by a financial institution to purchase the home at the selected price range. The user can also enter or select from different property types from which buyers may be looking, such as single family home, town home, or semi-detached home.

The user can search and view the full buyer profile by selected one or more of the buyer identifiers in the search results screen (e.g., as shown in FIG. 6B).

The buyer profile retrieved by the user can be saved for future use. For example, if the user regularly lists properties that sell for over $500,000 in a specific area X of a city, the user can save search criteria for use with any buyers looking for properties listed for over $500,000 in area X. The selections that the user may select among can include, but are not limited to, zip code, number of bedrooms, number of bathrooms, number of levels, architectural style of property, age of home, availability of parking or a garage, square footage, fireplaces, exterior siding, basement, type of utilities, swimming pool, and a deck.

After the user makes the selections that are applicable to the seller's property, the user can transmit the selections to the server and receive the buyer results. The computer terminal, for example, will display a list of matching buyers, by buyer identifier, for which the user's property selections matched buyer's requirements. If the user finds that the server returns results of more than a predetermined number of buyers, the user can select additional retrieval information to narrow the number of matching buyers. For example, if the database returns a list of 200 buyers, the user can add an additional selection requirements based on other features of the property, such as a swimming pool, to narrow the search to buyers looking for a swimming pool. (See also steps 174-175 of FIG. 7). Once the buyer list is more manageable to the user, the user can then contact any of the listed buyers to present the specific property of the seller.

If the user selects a buyer or several buyers, the user can view additional information regarding the buyer's property requirements entered into the database. For example, the user can view the buyer's full profile to determine whether to contact the buyer or the buyer's real estate agent. The full profile can include the buyer's or agent's telephone number and best times to call. Alternatively, the user can select to view buyer's full information to determine the buyer's other criteria or to see if buyer has other buyer identifiers covering other property criteria. For example, the buyer identifier may indicate that the buyer is looking for a single-family home in one geographic area, but looking for a town home in another geographic area. The user can then save and/or print the buyer's profile, for example. (See also step 176 of FIG. 7).

At any stage of the user's search for a buyer in the system of the present invention, the user can return to the previous screen, select and deselect a buyer and repeat any of the above steps, or exit the system.

The above selection criteria are given as examples only. However, any one of the above or any selection criteria that may be of interest to a wide variety of buyers may be provided for in the system as a selection for the buyer or a search tool for the seller.

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 6.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred through communications interface 224 are in the form of signals 228, which may be electronic, electromagnetic, optical or other signals capable of being received by communications interface 224. These signals 228 are provided to communications interface 224 through a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received through communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Although the invention has been described based upon these preferred embodiments, it would be clear to those skilled in the art that certain modifications, variations, and alternative constructions would be apparent, while remaining within the spirit and scope of the invention. In order to determine the metes and bounds of the invention, therefore, reference should be made to the appended claims.

What is claimed is:

1. A method for providing buyer real estate information, the method comprising:
receiving at least one buyer related search criterion;
performing a search of a data repository containing buyer real estate information using the at least one selected buyer related search criterion; and
identifying any buyer in the data repository matching the at least one selected buyer related search criterion.

2. The method according to claim 1, further comprising:
providing an option to store a list of any buyer identified.

3. The method according to claim 1, further comprising:
receiving personal information relating to a buyer;
generating a unique buyer identifier associated with the buyer; and
receiving and storing at least one buyer profile associated with the buyer identifier.

4. The method according to claim 3, wherein receiving personal information relating to the buyer comprises:
receiving the buyer name, address, and telephone number

5. The method according to claim 3, wherein generating a unique buyer identifier comprises:
randomly assigning the buyer identifier.

6. The method according to claim 3, wherein generating a unique buyer identifier comprises:
sequentially assigning the buyer identifier.

7. The method according to claim 3, wherein receiving and storing the at least one buyer profile associated with the buyer identifier comprises:
receiving and storing buyer real estate requirements

8. The method according to claim 1, wherein the at least one buyer related search criterion includes a price range.

9. The method according to claim 1, wherein the at least one buyer related search criterion includes a geographical area.

10. The method according to claim 3, wherein receiving and storing the at least one buyer profile comprises:
receiving and storing buyer financing information.

11. The method according to claim 3, wherein receiving and storing the at least one buyer profile comprises:
receiving and storing buyer contact information.

12. The method according to claim 1, wherein performing a search of a data repository containing buyer real estate information using the at least one selected buyer related search criterion comprises:
searching a selected price range.

13. The method according to claim 1, wherein performing a search of a data repository containing buyer real estate information using the at least one selected buyer related search criterion comprises:
searching a selected geographical area.

14. The method according to claim 1, further comprising:
displaying any identified buyer on a terminal.

15. The method according to claim 3, wherein receiving personal information relating to the buyer comprises:
receiving audio information.

16. A system for providing buyer real estate information, the system comprising:
a server;
a user interface functioning via the server;
a repository accessible by the server; and
a receiving device for receiving data from the server;
wherein at least one buyer related search criterion is received;
wherein a search of a data repository containing buyer real estate information using the at least one selected buyer related search criterion is performed; and
wherein any buyer in the data repository matching the at least one selected buyer related search criterion is identified.

17. The system according to claim 16, wherein the server is housed in a terminal.

18. The system according to claim 17, wherein the terminal is selected from a group comprising a personal computer, a minicomputer, a microcomputer, and a mainframe.

19. The system according to claim 16, wherein the server is coupled to a network.

20. The system according to claim 19, wherein the network is selected from a group comprising the Internet, the World Wide Web, a local area network (LAN) a wide area network (WAN) and a wireless communication network.

21. The system according to claim 19, wherein the server is coupled to the network via a coupling.

22. The system according to claim 21, wherein the coupling is selected from the group comprising a wired connection, a wireless connection, and a fiber optic connection.

23. The system according to claim 16, wherein the repository is housed on the server.

24. The system according to claim 16, wherein the receiving device is selected from the group comprising a personal computer (PC), minicomputer, microcomputer, mainframe computer, telephone device, personal digital assistant (PDA), and wireless device with a processor, display, and capability of connecting to the network.

25. A computer program product comprising a computer usable medium having control logic stored therein for causing a computer to provide buyer real estate information, the control logic comprising:
first computer readable program code means for receiving at least one buyer related search criterion;
second computer readable program code means for performing a search of a data repository containing buyer real estate information using the at least one selected buyer related search criterion; and
third computer readable program code means for identifying any buyer in the data repository matching the at least one selected buyer related search criterion.

26. A method for providing a buyer profile in a buyer real estate information system, the method comprising:
populating information relating to a buyer into a user terminal;
transmitting the information to a server through a network;
retrieving a buyer identifier;
populating buyer real estate requirements into a user terminal to create a buyer profile;
transmitting the requirement to the server;
performing a search of buyer profiles matching a selected criteria;
compiling a list of buyer identifiers associated with the buyer profiles matching the selected criteria; and
displaying the buyer profiles.
